(19) United States
(12) Patent Application Publication
(10) Pub. No.: US 2024/0281998 A1
(43) Pub. Date: Aug. 22, 2024

(54) DETECTION METHOD FOR DIRECTION OF SIGHT, APPARATUS, ELECTRONIC DEVICE AND STORAGE MEDIUM

(71) Applicant: Beijing Zitiao Network Technology Co., Ltd., Beijing (CN)

(72) Inventor: Zhaoxue WANG, Beijing (CN)

(21) Appl. No.: 18/443,662

(22) Filed: Feb. 16, 2024

(30) Foreign Application Priority Data
Feb. 20, 2023 (CN) 202310182114.1

(51) Int. Cl. G06T 7/73

(52) U.S. Cl. CPC G06T 7/73; G06T 2207/30201

(57) ABSTRACT

A method, an apparatus, an electronic device, and a storage medium for detecting a direction of sight are provided. The method includes: after emitting detection light to a cornea of a user, obtaining a first image by acquiring an image of the cornea, where at least one reflection light spot is displayed in the first image, and the reflection light spot is formed by the cornea reflecting the detection light; generating a first prediction diagram by processing the first image based on a pre-trained image processing model, where the first prediction diagram characterizes a probability of a pixel on the first image being a target pixel, and the target pixel is a pixel constituting the reflection light spot; determining a target position of the reflection light spot according to the first prediction diagram; and determining a gazing direction of the user based on the target position.

### CROSS-REFERENCE TO RELATED APPLICATION

The present application claims priority of the Chinese Patent Application No. 202310182114.1, filed on Feb. 20, 2023, the entire disclosure of which is incorporated herein by reference as part of the present application.

### TECHNICAL FIELD

Embodiments of the present disclosure relate to the field of computer vision, in particular to a method for detecting a direction of sight, an apparatus for detecting a direction of sight, an electronic device, and a storage medium.

### BACKGROUND

At present, with the development of various sensing technologies and display technologies, human-computer interaction methods are more efficient and diversified. The vision-based human-computer interaction technology has been widely used in many technical fields, such as virtual reality (VR), augmented reality (AR), and the like.

The implementation of vision-based human-computer interaction technology requires to capture the eye image of the user and detect the gazing direction of the user based on the image. The common vision detection algorithms may include the pupil-cornea reflection approach, etc.

However, in the current process of detecting the direction of the line of sight of the user based on the image, there may be problems of low detection accuracy and poor detection precision.

### SUMMARY

The embodiments of the present disclosure provide a method for detecting a direction of sight, an apparatus for detecting a direction of sight, an electronic device, and a storage medium, so as to overcome the problems of low detection accuracy and poor detection precision when detecting the direction of the line of sight.

In a first aspect, at least one embodiment of the present disclosure provides a method for detecting a direction of sight, and the method includes: after emitting detection light to a cornea of a user, obtaining a first image by acquiring an image of the cornea, where at least one reflection light spot is displayed in the first image, and the reflection light spot is formed by the cornea reflecting the detection light; generating a first prediction diagram by processing the first image based on a pre-trained image processing model, where the first prediction diagram characterizes a probability of a pixel on the first image being a target pixel, and the target pixel is a pixel constituting the reflection light spot; determining a target position of the reflection light spot according to the first prediction diagram; and determining a gazing direction of the user based on the target position of the reflection light spot.

In a second aspect, at least one embodiment of the present disclosure further provides an apparatus for detecting a direction of sight, and the apparatus includes: an acquisition module, configured to, after emitting detection light to a cornea of a user, obtain a first image by acquiring an image of the cornea, where at least one reflection light spot is displayed in the first image, and the reflection light spot is formed by the cornea reflecting the detection light; a processing module, configured to generate a first prediction diagram by processing the first image based on a pre-trained image processing model, where the first prediction diagram characterizes a probability of a pixel on the first image being a target pixel, and the target pixel is a pixel constituting the reflection light spot; a first determination module, configured to determine a target position of the reflection light spot according to the first prediction diagram; and a second determination module, configured to determine a gazing direction of the user based on the target position of the reflection light spot.

In a third aspect, at least one embodiment of the present disclosure further provides an electronic device, and the electronic device includes a processor and a memory being in communication connection to the processor; and one or more computer-executable instructions are stored on the memory, and the processor is configured to execute the one or more computer-executable instructions stored on the memory to implement a method for detecting a direction of sight, which includes: after emitting detection light to a cornea of a user, obtaining a first image by acquiring an image of the cornea, where at least one reflection light spot is displayed in the first image, and the reflection light spot is formed by the cornea reflecting the detection light; generating a first prediction diagram by processing the first image based on a pre-trained image processing model, where the first prediction diagram characterizes a probability of a pixel on the first image being a target pixel, and the target pixel is a pixel constituting the reflection light spot; determining a target position of the reflection light spot according to the first prediction diagram; and determining a gazing direction of the user based on the target position of the reflection light spot.

In a fourth aspect, at least one embodiment of the present disclosure further provides a computer-readable storage medium, the computer-readable storage medium is configured to store computer-executable instructions, and the computer-executable instructions, when executed by a processor, cause the processor to implement the method for detecting the direction of sight according to any one of the embodiments of the present disclosure.

In a fifth aspect, at least one embodiment of the present disclosure further provides a computer program product, the computer program product includes a computer program, and the computer program, when executed by a processor, is configured to implement the method for detecting the direction of sight according to any one of the embodiments of the present disclosure.

For the method for detecting the direction of sight, the apparatus for detecting the direction of sight, the electronic device, and the storage medium provided by the embodiments of the present disclosure, after detection light is emitted to a cornea of a user, image acquisition is performed for the cornea to obtain a first image, at least one reflection light spot is displayed in the first image, and the reflection light spot is formed by the cornea reflecting the detection light; the first prediction diagram is generated by processing the first image based on a pre-trained image processing model, the first prediction diagram characterizes a probability of a pixel on the first image being a target pixel, and the target pixel is a pixel constituting the reflection light spot; a target position of the reflection light spot is determined according to the first prediction diagram; and a gazing direction of the user is determined based on the target position of the reflection light spot. The reflection light spot in the first image is identified by using the pre-trained image processing model to process the first image taken for the cornea of the user, and the first prediction diagram characterizing the recognition probability corresponding to the reflection light spot is obtained, so that the target position of the reflection light spot can be accurately determined; and further, the detection of the gazing direction of the user is implemented based on the target position, so as to avoid the problems of low detection accuracy and poor detection precision of the gazing direction caused by the inaccurate position or recognition error of the reflection light spot, thereby improving the detection accuracy of the gazing direction.

### BRIEF DESCRIPTION OF THE DRAWINGS

In order to clearly illustrate the technical solutions of the embodiments of the present disclosure, the drawings of the embodiments will be briefly described in the following. It is obvious that the described drawings are only related to some embodiments of the present disclosure and thus are not limitative to the present disclosure. Those skilled in the art can also obtain new drawings based on these described drawings without any inventive work.

FIG. 1 is an application scenario diagram of a method for detecting a direction of sight provided by an embodiment of the present disclosure;

FIG. 2 is a flowchart of a method for detecting a direction of sight provided by an embodiment of the present disclosure;

FIG. 3 is a schematic diagram of generating a reflection light spot provided by an embodiment of the present disclosure;

FIG. 4 is a schematic diagram of a first prediction diagram provided by an embodiment of the present disclosure;

FIG. 5 is a flowchart of specific implementation of Step S103 in the embodiment as illustrated in FIG. 2;

FIG. 6 is a flowchart of specific implementation of Step S104 in the embodiment as illustrated in FIG. 2;

FIG. 7 is another flowchart of a method for detecting a direction of sight provided by an embodiment of the present disclosure;

FIG. 8 is a flowchart of specific implementation of Step S206 in the embodiment as illustrated in FIG. 7;

FIG. 9 is a schematic diagram of generating a target image provided by an embodiment of the present disclosure;

FIG. 10 is a flowchart of specific implementation of Step S209 in the embodiment as illustrated in FIG. 7;

FIG. 11 is a block diagram of an apparatus for detecting a direction of sight provided by an embodiment of the present disclosure;

FIG. 12 is a schematic structural diagram of an electronic device provided by an embodiment of the present disclosure; and

FIG. 13 is a schematic structural diagram of hardware of an electronic device provided by an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

It should be noted that the user information (including but not limited to user device information, user personal information, etc.) and data (including but not limited to data used for analysis, stored data, displayed data, etc.) involved in the present disclosure are authorized by users or fully authorized by all parties. The collection, usage and processing of relevant data is required to comply with the relevant laws, regulations and standards of relevant countries and regions, and corresponding operation portals are provided for users to choose to authorize or refuse.

The application scenarios of the embodiments of the present disclosure are introduced below.

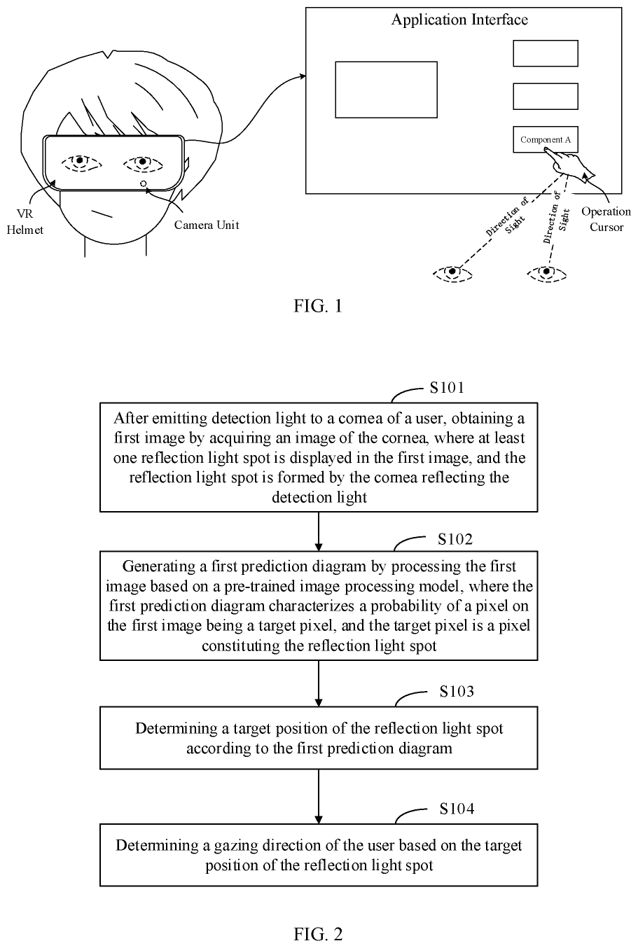

FIG. 1 is an application scenario diagram of a method for detecting a direction of sight provided by an embodiment of the present disclosure. The method for detecting a direction of sight provided by the embodiments of the present disclosure can be applied to scenarios such as virtual reality, augmented reality and the like. For example, the method for detecting a direction of sight can be applied to the process of visual-based human-computer interaction in the virtual reality, augmented reality, etc. Specifically, the method provided by the embodiments of the present disclosure may be applied to terminal devices, such as a smart phone, smart glasses, a virtual reality helmet, etc. As illustrated in FIG. 1, taking a virtual reality helmet (e.g., a VR helmet illustrated in the figure) as an example, after the user wears the virtual reality helmet, the virtual reality helmet displays an application interface through the built-in display screen, and the virtual reality helmet simultaneously detects the direction of sight of the user through the camera unit and generates a corresponding operation cursor on the display screen based on the direction of sight of the user, so as to implement the human-computer interaction based on the operation cursor. For example, as illustrated in the figure, when the operation cursor stays on the component A displayed in the application interface for two seconds, the corresponding function of the component A is triggered.

The implementation of vision-based human-computer interaction technology requires to capture the eye image of the user and detect the gazing direction of the user based on the image. The common vision detection algorithms may include the pupil-cornea reflection approach, etc. In this process, infrared light is usually emitted through a preset LED light source, the infrared light is reflected on the cornea of the user, and the reflected light enters the image acquisition unit of the terminal device, such as a camera, thereby forming a reflection light spot in the image taken by the image acquisition unit. Then, based on the detection of the reflection light spot, the center position of the cornea (i.e., the center of cornea curvature) can be calculated. Thus, based on the position of the cornea center and the position of the pupil center, the vector that characterizes the direction of sight can be obtained, and the detection process of the direction of sight is completed.

In the process described above, recognizing the position of the reflection light spot is an important step of implementing the detection of the direction of sight. Currently, regarding the position recognition method of the reflection light spot, a preset brightness threshold is usually used to sift through images captured by the image acquisition unit, and the set of similar points whose brightness is larger than the brightness threshold is determined as the reflection light spot. However, in the actual application process, on the one hand, the differences of the eye shape of users, the configuration of terminal devices (e.g., the position of the camera with respect to the eyes) and the like may cause that the setting of the brightness threshold cannot be optimal; and on the other hand, in the cornea tissue of the eyes of the users, additional reflection light spots may be generated due to the existence of tears and diffuse reflection, which may interfere with the reflection light spot actually generated by the light source. Based on the above reasons, the position recognition of the reflection light spot is not accurate, which further leads to the problem of low detection accuracy and poor detection precision in the detection process of the direction of sight. The embodiments of the present disclosure provide a method for detecting a direction of sight, which optimizes the positioning precision of the reflection light spot by using an image processing model to locate the reflection light spot (e.g., a new localization method for the reflection light spot), thereby solving the problems described above.

Referring to FIG. 2, FIG. 2 is a flowchart of a method for detecting a direction of sight provided by an embodiment of the present disclosure. The method of the present embodiment can be applied to a terminal device or other electronic devices with similar functions, and the method for detecting a direction of sight includes:

Step S101: after emitting detection light to a cornea of a user, obtaining a first image by acquiring an image of the cornea, where at least one reflection light spot is displayed in the first image, and the reflection light spot is formed by the cornea reflecting the detection light.

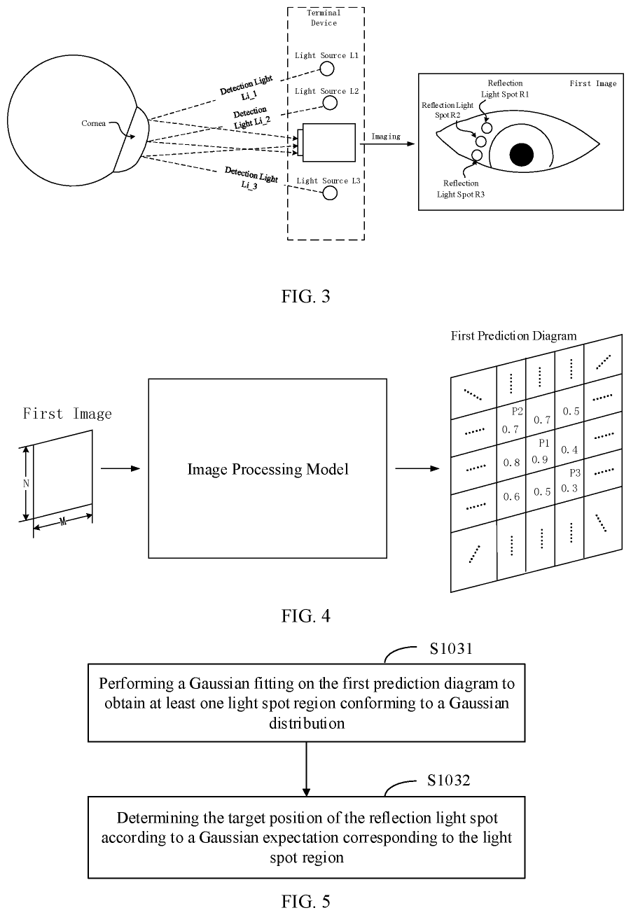

For example, referring to the schematic diagram of the application scenario illustrated in FIG. 1, the terminal device, for example, is a VR headset, and a light source for emitting the detection light is provided in the terminal device. For example, the detection light is infrared light. The light source may emit the detection light to the eye of the user, and the detection light is reflected on the cornea. When the image acquisition of the cornea of the user is performed through a camera unit, the detection light that is reflected on the cornea can be received, so that the corresponding reflection light spot is generated in the obtained image. FIG. 3 is a schematic diagram of generating a reflection light spot provided by an embodiment of the present disclosure. As illustrated in FIG. 3, a camera unit facing the eye of the user and a plurality of light sources are provided in the terminal device. The plurality of light sources are illustrated as the light source L1, light source L2, and light source L3 in the figure. After the light sources are turned on, the light source L1, light source L2, and light source L3 respectively emit the detection light Li_1, detection light Li_2, and detection light Li_3 to the cornea of the user. Ignoring situations such as diffuse reflection or the like, after being reflected by the cornea, the above-mentioned detection light may enter the camera unit and be imaged in the camera unit, so that the corresponding reflection light spot R1, reflection light spot R2 and reflection light spot R3 are formed in the first image P1 photographed by the camera unit.

Step S102: generating a first prediction diagram by processing the first image based on a pre-trained image processing model, where the first prediction diagram characterizes a probability of a pixel on the first image being a target pixel, and the target pixel is a pixel constituting the reflection light spot.

For example, after obtaining the first image, the image processing model is invoked to process the first image, and a thermodynamic diagram that characterizes the position-probability relationship of the reflection light spot is output, i.e., the first prediction diagram. Specifically, in a possible implementation method, the size of the first prediction diagram may be the same as the size of the first image, that is, each pixel in the first prediction diagram corresponds to each pixel in the first image in one-to-one correspondence. For example, the first prediction diagram may be a grayscale diagram, and the pixel value of each pixel in the first prediction diagram, i.e., the grayscale value, characterizes the probability that the pixel is the target pixel that forms the reflection light spot. FIG. 4 is a schematic diagram of a first prediction diagram provided by an embodiment of the present disclosure. As illustrated in FIG. 4, the size of the first image is M×N, where M and N are positive integers and characterize the number of transverse pixels and the number of longitudinal pixels of the first image. More specifically, for example, M=128, N=256, i.e., the first image is an image with a size of 128×256. Then the first image is input to the image processing model, and after being processed by the image processing model, the first prediction diagram with the same size is output, i.e., the image size of the first prediction diagram is also M×N, and the pixels of the first prediction diagram and the pixels of the first image are in one-to-one correspondence, which is not repeated here again. The pixels on the first prediction diagram obtained after the processing by the image processing model characterize the probability that the corresponding pixels on the first image are target pixels. Referring to the figure, for example, the pixel value corresponding to the pixel P1 is 0.9, which characterizes the probability that the pixel P1 in the first image is the target pixel that constitutes the reflection light spot is 90%; the pixel value corresponding to the pixel P2 is 0.7, which characterizes the probability that the pixel P2 in the first image is the target pixel that constitutes the reflection light spot is 70%; and the pixel value corresponding to the pixel P3 is 0.3, which characterizes the probability that the pixel P3 in the first image is the target pixel that constitutes the reflection light spot is 30%. If the pixels mentioned above are target pixels, then the pixel region constituted by the plurality of pixels mentioned above is the reflection light spot in the first image.

Further, for example, the image processing model may be a pre-trained convolutional neural networks (CNN) model. The CNN is a type of feedforward neural networks including convolutional computations and with deep structures, and is also one of the representative algorithms of deep learning. In the case that the light source is turned on, the image processing model can be obtained by acquiring the corresponding cornea image for corneas of different users, labeling the reflection light spot in the cornea image to obtain the labeled image, and utilizing the labeled image as a training sample to train the initial convolutional neural networks model until the model converges. The specific training method of the convolutional neural networks model can be clearly understood and implemented by those skilled in the art, which is not repeated here.

Step S103: determining a target position of the reflection light spot according to the first prediction diagram.

For example, after obtaining the first prediction diagram, the position of the reflection light spot is predicted based on the first prediction diagram. As illustrated in FIG. 4, the pixel value of each pixel in the first prediction diagram characterizes the probability of the pixel being the target pixel. The detection light is reflected by the cornea and is imaged on the first image. After the generated reflection light spot being predicted by the image processing model, in the generated first prediction diagram, there is a characteristic that the pixel value of the pixel closer to the center of the reflection light spot is higher and the pixel value of the pixel farther away from the center of the reflection light spot is lower, where the pixel value characterizes the probability of the pixel being the target pixel. In the first prediction diagram, from the center pixel of the reflection light spot to the edge pixel of the reflection light spot, pixel values of the pixels comply with the Gaussian distribution. Therefore, in a possible implementation method, as illustrated in FIG. 5, the specific implementation method of Step S103 includes:

Step S1031: performing a Gaussian fitting on the first prediction diagram to obtain at least one light spot region conforming to a Gaussian distribution; and

Step S1032: determining the target position of the reflection light spot according to a Gaussian expectation corresponding to the light spot region.

For example, based on the pixel value of each pixel in the first prediction diagram, the Gaussian function is utilized to fit the corresponding pixel value of each pixel in the first prediction diagram. In one possible implementation method, the hybrid Gaussian function can be utilized to fit, so as to obtain a more accurate fitting result. The specific implementation method of utilizing the Gaussian function to perform the Gaussian fitting can be clearly understood and implemented by those skilled in the art, which is not repeated here. Then, according to the fitting result, the light spot region where at least one pixel value satisfies the Gaussian distribution can be obtained. The pixel value of the central part of the light spot region is high, and the pixel value of the edge part is low, obeying the Gaussian distribution entirely. Then, based on the Gaussian expectation of the light spot region, the position of the pixel corresponding to the Gaussian expectation value (i.e., the Gaussian average value) is determined as the target position of the reflection light spot. More specifically, for example, the center point of the region corresponding to the plurality of pixels that corresponds to the Gaussian expectation value is determined as the target position of the reflection light spot.

Step S104: determining a gazing direction of the user based on the target position of the reflection light spot.

For example, after determining the reflection light spot, the vector formed by the pupil center and the target position (center point) of the reflection light spot changes with change in the gazing direction. Therefore, the gazing direction of the user can be determined based on the target position of the reflection light spot and the measured pupil center.

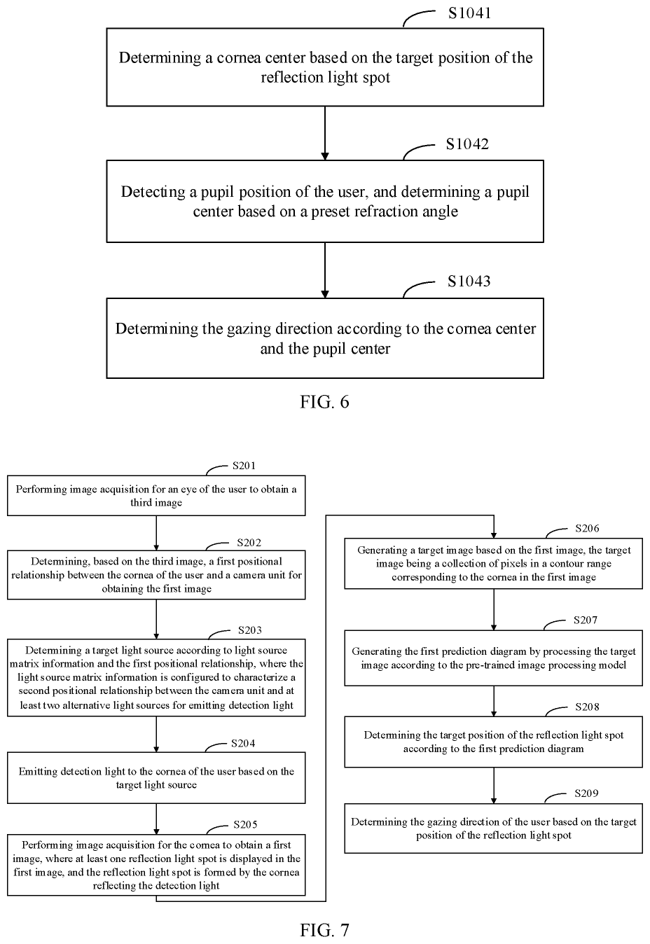

In a possible implementation method, as illustrated in FIG. 6, the specific implementation method of Step S104 includes:

Step S1041: determining a cornea center based on the target position of the reflection light spot;

Step S1042: detecting a pupil position of the user, and determining a pupil center based on a preset refraction angle; and

Step S1043: determining the gazing direction according to the cornea center and the pupil center.

For example, after determining the target position of the reflection light spot, the cornea center can be determined based on the position and the number of light sources that emit detection light. The specific implementation method of determining the cornea center based on the target position of the reflection light spot can be clearly understood and implemented by those skilled in the art, which is not repeated here. Then, the pupil position of the user can be determined by performing an image acquisition on the eye of the user and performing identification on the acquired image. For example, the pupil position can be determined based on the acquired first image. In addition, considering that the pupil may refract light on the surface of the cornea, the preset refraction angle is added based on the pupil position to obtain the pupil center. Further, based on the adjacency of the cornea center and the pupil center, the gazing direction can be obtained by adding a preset deflection angle (e.g., about 5 degrees).

In the embodiments of the present disclosure, after detection light is emitted to the cornea of the user, image acquisition is performed for the cornea to obtain the first image, at least one reflection light spot is displayed in the first image, and the reflection light spot is formed by the cornea reflecting the detection light; the first prediction diagram is generated by processing the first image based on the pre-trained image processing model, the first prediction diagram characterizes a probability of the pixel on the first image being the target pixel, and the target pixel is a pixel constituting the reflection light spot; the target position of the reflection light spot is determined according to the first prediction diagram; and the gazing direction of the user is determined based on the target position of the reflection light spot. The reflection light spot in the first image is identified by using the pre-trained image processing model to process the first image taken for the cornea of the user, and the first prediction diagram characterizing the recognition probability corresponding to the reflection light spot is obtained, so that the target position of the reflection light spot can be accurately determined; and further, the detection of the gazing direction of the user is implemented based on the target position, so as to avoid the problems of low detection accuracy and poor detection precision of the gazing direction caused by the inaccurate position or recognition error of the reflection light spot, thereby improving the detection accuracy of the gazing direction.

Referring to FIG. 7, FIG. 7 is another flowchart of a method for detecting a direction of sight provided by an embodiment of the present disclosure. Based on the embodiment as illustrated in FIG. 2, the present embodiment further specifies Step S103 and adds a step of mask processing. The method for detecting a direction of sight includes the following.

Step S201: performing image acquisition for an eye of the user to obtain a third image.

Step S202: determining, based on the third image, a first positional relationship between the cornea of the user and a camera unit for obtaining the first image.

For example, for different users, because of the differences in the wearing style of terminal devices, facial contours, and bones, certain difference conditions may exist in the process of detecting the direction of sight for different users, such as the positional relationship between the cornea of the user and the camera unit, and the positional relationship between the cornea and the light source. The above difference conditions may lead to the problem of inaccurate positioning of the target position of the reflection light spot. Therefore, in response to the above problem, before actually detecting the cornea of the user (obtaining the first image), the third image is first acquired for the cornea of the user, and the first positional relationship between the camera unit and the cornea of the user is determined based on the content of the third image. More specifically, the first positional relationship, for example, is the distance between the camera unit and the cornea of the user, the intersection between the optical axis of the camera and the plane where the cornea of the user is positioned, or the like. The first positional relationship can be represented by the feature vector, and the specific implementation method can be implemented based on the pre-trained direction-orientation model, which is not repeated here.

Step S203: determining a target light source according to light source matrix information and the first positional relationship, where the light source matrix information is configured to characterize a second positional relationship between the camera unit and at least two alternative light sources for emitting detection light.

For example, the preset light source matrix information is read. The light source matrix information is information that describes the positional relationship between the light source and the camera unit, i.e., the second positional relationship. More specifically, for example, when there are a plurality of light sources, the light source matrix information records the information such as the arrangement of light sources around the camera unit (e.g., rectangular arrangement, hexagonal arrangement), the distance between each light source and the camera unit, and the like. Based on the light source matrix information and the spatial position determined in the above steps, one or more alternative light sources are determined as the target light sources, so that the reflection light spot generated through the light source emitting the detection light can be positioned at the ideal position in the first image, which avoids the problem of such as coincidence, interference or the like and further avoids causing the problem that the pixel value of the pixel of the light spot region in the generated first prediction diagram does not satisfy the Gaussian distribution, thus avoiding affecting the positioning precision of the reflection light spot.

In the embodiment step, by acquiring the third image in advance, selecting a suitable target light source based on the third image and the light source matrix information, and emitting the detection light based on the target light source, the quality of the generated reflection light spot is improved, thereby improving the positioning precision of the reflection light spot.

Step S204: emitting detection light to the cornea of the user based on the target light source.

Step S205: performing image acquisition for the cornea to obtain a first image, where at least one reflection light spot is displayed in the first image, and the reflection light spot is formed by the cornea reflecting the detection light.

Step S206: generating a target image based on the first image, the target image being a collection of pixels in a contour range corresponding to the cornea in the first image.

For example, in different cases, when the camera unit acquires the image of the cornea of the user, the camera unit usually acquires an image including the eye of the user. In addition to the image content of the cornea of the user, the image further includes other image contents, such as eyelids, eyelashes, etc. The above contents may affect the positioning of the reflection light spot. In one case, in order to position the reflection light spot more accurately, when training the image processing model, the image processing model is required to receive additional samples for training, so as to distinguish the reflection light spot from other interfering image elements, which may cause additional model training costs. In another case, the conventionally trained image processing model is directly used for processing, which may cause a problem of identifying the wrong reflection light spot and affecting the accuracy of the detection result.

Therefore, in the present embodiment, after obtaining the first image, the first image is processed to obtain a collection of pixels in the contour range corresponding to the cornea in the first image, i.e., the target image. Then a subsequent step is performed based on the target image, thereby solving the above problems.

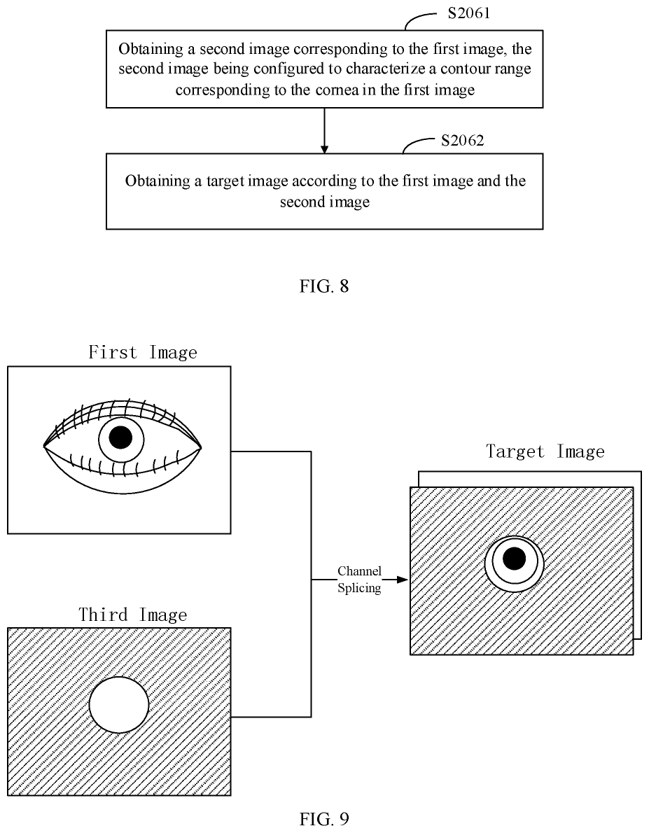

For example, as illustrated in FIG. 8, the specific implementation steps of Step S2061 include:

Step S2061: obtaining a second image corresponding to the first image, the second image being configured to characterize a contour range corresponding to the cornea in the first image; and

Step S2062: obtaining a target image according to the first image and the second image.

For example, firstly, according to the size of the first image, a mask image with the same size as the first image is generated, i.e., the second image. The second image may be used to cover the partial content of the first image, thereby characterizing the contour range corresponding to the cornea in the first image.

For example, the second image is the second binary diagram with the same image size as the first image. The specific implementation step of Step S2062 includes: performing channel splicing based on the first image and the second image to obtain the target image.

FIG. 9 is a schematic diagram of generating a target image provided by an embodiment of the present disclosure. As illustrated in FIG. 9, the target image is a splicing of the first image and the second image in the channel dimension. For example, the size of the first image is M×N, and the corresponding number of channels is equivalent to 1; similarly, the size of the second image is M×N, and the corresponding number of channels is equivalent to 1; and the first image and the second image are channel-spliced to obtain a target image with the size of M×N×2. Then the target image obtained after splicing is input into the image processing model, and by masking the first image with the second image (the second binary diagram), the image processing model only processes the image content in the contour range corresponding to the cornea of the user when the image processing model processes the target image, thereby reducing the data processing amount of the image processing model, improving the calculation speed and improving the accuracy of the obtained first prediction diagram.

Step S207: generating the first prediction diagram by processing the target image according to the pre-trained image processing model.

Step S208: determining the target position of the reflection light spot according to the first prediction diagram.

For example, after obtaining the target image, the specific implementation method of processing the target image based on the pre-trained image processing model to generate the first prediction diagram is the same as the specific implementation method of processing the first image based on the image processing model to generate the first prediction diagram in the embodiment illustrated in FIG. 2. Training the image processing model and the specific implementation method are introduced in the embodiment illustrated in FIG. 2, and details are not repeated here.

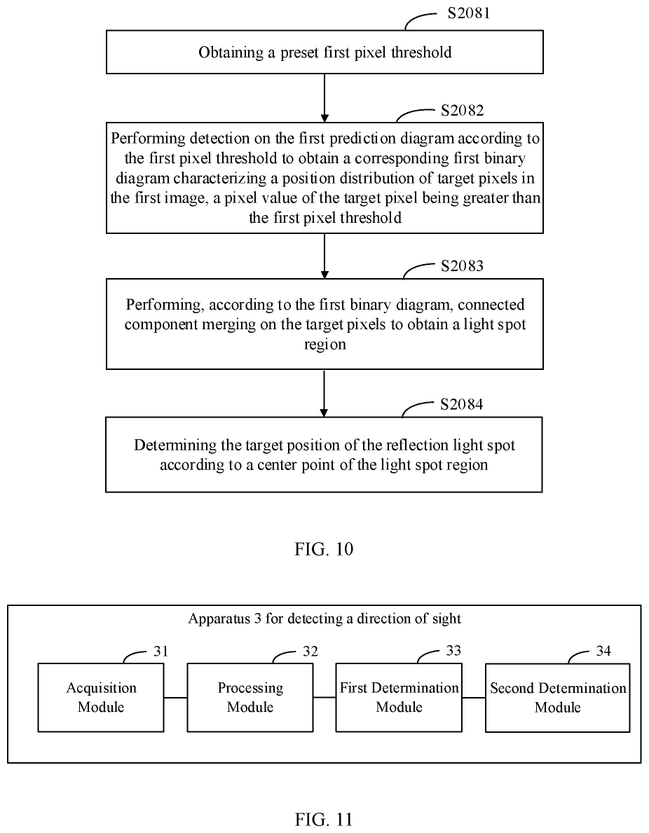

Then the probability threshold is used to filter the first prediction diagram, and the collection of pixels with a larger probability (the target pixels) is determined as the reflection light spot, so that the target position is determined based on the contour of the reflection light spot. Specifically, in a possible implementation, as illustrated in FIG. 10, the specific implementation method of Step S208 includes:

Step S2081: obtaining a preset first pixel threshold.

Step S2082: performing detection on the first prediction diagram according to the first pixel threshold to obtain a corresponding first binary diagram characterizing a position distribution of target pixels in the first image, a pixel value of the target pixel being greater than the first pixel threshold.

Step S2083: performing, according to the first binary diagram, connected component merging on the target pixels to obtain a light spot region.

Step S2084: determining the target position of the reflection light spot according to a center point of the light spot region.

For example, the first pixel threshold characterizes the probability threshold, i.e., the condition that the pixel is determined as the target pixel. When the pixel value corresponding to the pixel is greater than the first pixel threshold, the pixel is characterized as having a high probability of being the target pixel. Conversely, when the pixel value corresponding to the pixel is smaller than the first pixel threshold, the pixel is characterized as having a low probability of being the target pixel. After the first prediction diagram is detected based on the first pixel threshold, the pixel in the first prediction diagram whose pixel value is greater than the first pixel threshold is set to 1, and the pixel in the first prediction diagram whose pixel value is smaller than the first pixel threshold is set to 0, thereby obtaining a binary diagram, i.e., the first binary diagram. Then, based on the image feature of the reflection light spot, the connected component merging is performed on the “1” regions corresponding to the first binary diagram, and the regions are fitted into the symmetrical region to obtain the light spot region. Then, based on the position coordinates of the pixels in the light spot region, the center point, e.g., the target position of the reflection light spot, is determined.

In the present embodiment, the first binary diagram characterizing the light spot distribution is obtained by using the first pixel threshold to detect the first prediction diagram, which achieves the fast and accurate positioning of the reflection light spot, and then the target position of the reflection light spot is determined based on the coordinates of the pixels in the first binary diagram. Combined with the step of dynamic selection of the light source in the previous steps, a plurality of light spot regions can be ensured to be independent of each other, which reduces the interference, and avoids the appearance of the irregular light spot region, so that the first binary diagram can accurately show the light spot region corresponding to the reflection light spot, thereby ensuring the positioning accuracy of the reflection light spot on the basis of improving the detection speed.

Step S209: determining the gazing direction of the user based on the target position of the reflection light spot.

In the present embodiment, the implementation method of Step S210 is the same as that of Step S204 in the embodiment illustrated in FIG. 2 of the present disclosure, which is not repeated here.

Corresponding to the method for detecting a direction of sight of the above embodiments, FIG. 11 is a block diagram of an apparatus for detecting a direction of sight provided by an embodiment of the present disclosure. To illustrate conveniently, only those parts relevant to the embodiments of the present disclosure are illustrated in the figure. Referring to FIG. 11, the apparatus 3 for detecting a direction of sight includes an acquisition module 31, a processing module 32, a first determination module 33, and a second determination module 34.

The acquisition module 31 is configured to, after emitting detection light to a cornea of a user, obtain a first image by acquiring an image of the cornea, wherein at least one reflection light spot is displayed in the first image, and the reflection light spot is formed by the cornea reflecting the detection light.

The processing module 32 is configured to generate a first prediction diagram by processing the first image based on a pre-trained image processing model, wherein the first prediction diagram characterizes a probability of a pixel on the first image being a target pixel, and the target pixel is a pixel constituting the reflection light spot.

The first determination module 33 is configured to determine a target position of the reflection light spot according to the first prediction diagram.

The second determination module 34 is configured to determine a gazing direction of the user based on the target position of the reflection light spot.

In an embodiment of the present disclosure, the first determination module 33 is specifically configured to: obtain a preset first pixel threshold; perform detection on the first prediction diagram according to the first pixel threshold to obtain a corresponding first binary diagram characterizing a position distribution of target pixels in the first image, where a pixel value of the target pixel is greater than the first pixel threshold; perform, according to the first binary diagram, connected component merging on the target pixels to obtain a light spot region; and determine the target position of the reflection light spot according to a center point of the light spot region.

In an embodiment of the present disclosure, the first determination module 33 is specifically configured to: perform a Gaussian fitting on the first prediction diagram to obtain at least one light spot region conforming to a Gaussian distribution; and determine the target position of the reflection light spot according to a Gaussian expectation corresponding to the light spot region.

In an embodiment of the present disclosure, the acquisition module 31 is further configured to: obtain a second image corresponding to the first image, where the second image is configured to characterize a contour range corresponding to the cornea in the first image; and obtain a target image according to the first image and the second image, where the target image is a collection of pixels in the contour range of the first image. The processing module 32 is specifically configured to: generate the first prediction diagram by processing the target image according to the pre-trained image processing model.

In an embodiment of the present disclosure, the second image is a second binary diagram with an identical image size as the first image. When the target image is obtained according to the first image and the second image, the acquisition module 31 is specifically configured to: obtain an image size corresponding to the first image and the second image, and perform channel splicing based on the first image and the second image to obtain the target image.

In an embodiment of the present disclosure, the second determining module 34 is specifically configured to: determine a cornea center based on the target position of the reflection light spot; detect a pupil position of the user, and determine a pupil center based on a preset refraction angle; and determine the gazing direction according to the cornea center and the pupil center.

In an embodiment of the present disclosure, before obtaining the first image by acquiring the image of the cornea, the acquisition module 31 is further configured to: perform image acquisition for an eye of the user to obtain a third image; determine, based on the third image, a first positional relationship between the cornea of the user and a camera unit for obtaining the first image; determine a target light source according to light source matrix information and the first positional relationship, where the light source matrix information is configured to characterize a second positional relationship between the camera unit and at least two alternative light sources for emitting detection light; and emit detection light to the cornea of the user based on the target light source.

For example, the acquisition module 31, the processing module 32, the first determination module 33, and the second determination module 34 are connected sequentially. The apparatus 3 for detecting the direction of sight provided by the embodiments of the present disclosure can execute the technical solutions of the above method embodiments and have similar implementation principles and technical effects, and details are not repeated here.

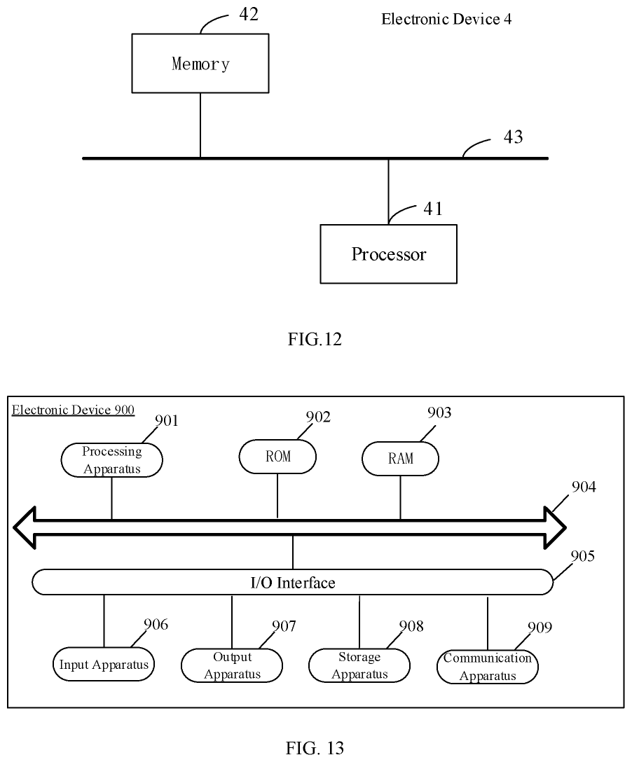

FIG. 12 is a schematic structural diagram of an electronic device provided by an embodiment of the present disclosure. As illustrated in FIG. 12, the electronic device 4 includes a processor 41 and a memory 42 that is in communication connection to the processor 41.

The memory 42 stores one or more computer-executable instructions. The processor 41 is configured to execute the one or more computer-executable instructions stored on the memory 42 to implement the method for detecting a direction of sight in the embodiments illustrated in FIG. 2 to FIG. 10.

For example, the processor 41 and the memory 42 are connected via the bus 43.

The relevant description can be understood by referring to the relevant description and effect corresponding to the steps in the embodiments corresponding to FIG. 2 to FIG. 10, and details are not repeated here.

The embodiments of the present disclosure further provide a computer-readable storage medium. The computer-readable storage medium stores computer-executable instructions. When the computer-executable instructions are executed by a processor, the computer-executable instructions cause the processor to implement the method for detecting the direction of sight provided by any one of the embodiments of the present disclosure corresponding to FIG. 2 to FIG. 10.

Referring to FIG. 13, FIG. 13 illustrates a schematic structural diagram of hardware of an electronic device 900 provided by an embodiment of the present disclosure. The electronic device 900 is, for example, applicable to implementing the method for detecting the direction of sight provided by the embodiments of the present disclosure. The electronic device 900 may be a terminal device or a server. For example, the terminal device may include but not be limited to mobile terminals, such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device, etc., and fixed terminals, such as a digital TV, a desktop computer, a smart home device, etc. It should be noted that the electronic device 900 shown in FIG. 13 is merely an example and will not impose any limitations on the function and the range of use of the embodiments of the present disclosure.

As illustrated in FIG. 13, the electronic device 900 may include a processing apparatus 901 (e.g., a central processing unit, a graphics processing unit, etc.), which may execute various appropriate actions and processing according to a program stored on a read-only memory (ROM) 902 or a program loaded from a storage apparatus 908 into a random access memory (RAM) 903. The random access memory (RAM) 903 further stores various programs and data required for operations of the electronic device 900. The processing apparatus 901, the ROM 902, and the RAM 903 are connected with each other through a bus 904. An input/output (I/O) interface 905 is also connected to the bus 904.

Usually, apparatuses below may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a speaker, a vibrator, or the like; a storage apparatus 908 including, for example, a magnetic tape, a hard disk, or the like; and a communication apparatus 909. The communication apparatus 909 may allow the electronic device 900 to perform wireless or wired communication with other electronic devices so as to exchange data. Although FIG. 13 shows the electronic device 900 having various apparatuses, it should be understood that, it is not required to implement or have all the apparatuses illustrated, and the electronic device 900 may alternatively implement or have more or fewer apparatuses.

For example, according to the embodiments of the present disclosure, the method described above with reference to the flowchart may be implemented as computer software programs. For example, the embodiments of the present disclosure include a computer program product, including a computer program carried on a non-transitory computer-readable medium, and the computer program includes program codes for executing the method as illustrated in the flowchart. In such embodiments, the computer program may be downloaded and installed from the network via the communication apparatus 909, or installed from the storage apparatus 908, or installed from the ROM 902. When executed by the processing apparatus 901, the computer program may implement the functions defined in the method provided by the embodiments of the present disclosure.

It should be noted that, in the context of the present disclosure, the computer-readable medium described above may be a computer-readable signal medium or a computer-readable storage medium, or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program codes contained on the computer-readable medium may be transmitted by using any suitable medium, including but not limited to an electric wire, a fiber-optic cable, radio frequency (RF) and the like, or any appropriate combination of them.

The above-described computer-readable medium may be included in the above-described electronic device, or may also exist alone without being assembled into the electronic device.

The above-mentioned computer-readable medium carries one or more programs, and the one or more programs, when executed by the electronic device, cause the electronic device to execute the method shown in the embodiments described above.

The computer program codes for performing the operations of the present disclosure may be written in one or more programming languages or a combination thereof. The above-described programming languages include but are not limited to object-oriented programming languages, such as Java, Smalltalk, C++, and also include conventional procedural programming languages, such as the “C” programming language or similar programming languages. The program codes may by executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flow chart and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation on the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the computer-readable medium may be a tangible medium that may contain or store programs for use by an instruction execution system, an apparatus, or a device, or for use in combination with an instruction execution system, an apparatus, or a device. The computer-readable medium may be a computer-readable signal medium or a computer-readable storage medium, or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them.

In the first aspect, at least one embodiment of the present disclosure provides a method for detecting a direction of sight, and the method includes: after emitting detection light to a cornea of a user, obtaining a first image by acquiring an image of the cornea, where at least one reflection light spot is displayed in the first image, and the reflection light spot is formed by the cornea reflecting the detection light; generating a first prediction diagram by processing the first image based on a pre-trained image processing model, where the first prediction diagram characterizes a probability of a pixel on the first image being a target pixel, and the target pixel is a pixel constituting the reflection light spot; determining a target position of the reflection light spot according to the first prediction diagram; and determining a gazing direction of the user based on the target position of the reflection light spot.

According to one or more embodiments of the present disclosure, determining the target position of the reflection light spot according to the first prediction diagram comprises: obtaining a preset first pixel threshold; performing detection on the first prediction diagram according to the first pixel threshold to obtain a corresponding first binary diagram characterizing a position distribution of target pixels in the first image, wherein a pixel value of the target pixel is greater than the first pixel threshold; performing, according to the first binary diagram, connected component merging on the target pixels to obtain a light spot region; and determining the target position of the reflection light spot according to a center point of the light spot region.

According to one or more embodiments of the present disclosure, determining the target position of the reflection light spot according to the first prediction diagram comprises: performing a Gaussian fitting on the first prediction diagram to obtain at least one light spot region conforming to a Gaussian distribution; and determining the target position of the reflection light spot according to a Gaussian expectation corresponding to the light spot region.

According to one or more embodiments of the present disclosure, the method further includes: obtaining a second image corresponding to the first image, wherein the second image is configured to characterize a contour range corresponding to the cornea in the first image; and obtaining a target image according to the first image and the second image, wherein the target image is a collection of pixels in the contour range of the first image, wherein generating the first prediction diagram by processing the first image based on the pre-trained image processing model, comprises: generating the first prediction diagram by processing the target image according to the pre-trained image processing model.

According to one or more embodiments of the present disclosure, the second image is a second binary diagram with an identical image size as the first image; and obtaining the target image according to the first image and the second image comprises: obtaining an image size corresponding to the first image and the second image, and performing channel splicing based on the first image and the second image to obtain the target image.

According to one or more embodiments of the present disclosure, determining the gazing direction of the user based on the target position of the reflection light spot comprises: determining a cornea center based on the target position of the reflection light spot; detecting a pupil position of the user, and determining a pupil center based on a preset refraction angle; and determining the gazing direction according to the cornea center and the pupil center.

According to one or more embodiments of the present disclosure, before obtaining the first image by acquiring the image of the cornea, the method further comprises: performing image acquisition for an eye of the user to obtain a third image; determining, based on the third image, a first positional relationship between the cornea of the user and a camera unit for obtaining the first image; determining a target light source according to light source matrix information and the first positional relationship, wherein the light source matrix information is configured to characterize a second positional relationship between the camera unit and at least two alternative light sources for emitting detection light; and emitting detection light to the cornea of the user based on the target light source.

In the second aspect, at least one embodiment of the present disclosure further provides an apparatus for detecting a direction of sight, and the apparatus includes: an acquisition module, configured to, after emitting detection light to a cornea of a user, obtain a first image by acquiring an image of the cornea, where at least one reflection light spot is displayed in the first image, and the reflection light spot is formed by the cornea reflecting the detection light; a processing module, configured to generate a first prediction diagram by processing the first image based on a pre-trained image processing model, where the first prediction diagram characterizes a probability of a pixel on the first image being a target pixel, and the target pixel is a pixel constituting the reflection light spot; a first determination module, configured to determine a target position of the reflection light spot according to the first prediction diagram; and a second determination module, configured to determine a gazing direction of the user based on the target position of the reflection light spot.

According to one or more embodiments of the present disclosure, the first determination module is specifically configured to: obtain a preset first pixel threshold; perform detection on the first prediction diagram according to the first pixel threshold to obtain a corresponding first binary diagram characterizing a position distribution of target pixels in the first image, where a pixel value of the target pixel is greater than the first pixel threshold; perform, according to the first binary diagram, connected component merging on the target pixels to obtain a light spot region; and determine the target position of the reflection light spot according to a center point of the light spot region.

According to one or more embodiments of the present disclosure, the first determination module is specifically configured to: perform a Gaussian fitting on the first prediction diagram to obtain at least one light spot region conforming to a Gaussian distribution; and determine the target position of the reflection light spot according to a Gaussian expectation corresponding to the light spot region.

According to one or more embodiments of the present disclosure, the acquisition module is further configured to: obtain a second image corresponding to the first image, where the second image is configured to characterize a contour range corresponding to the cornea in the first image; and obtain a target image according to the first image and the second image, where the target image is a collection of pixels in the contour range of the first image. The processing module is specifically configured to: generate the first prediction diagram by processing the target image according to the pre-trained image processing model.

According to one or more embodiments of the present disclosure, the second image is a second binary diagram with an identical image size as the first image. When the target image is obtained according to the first image and the second image, the acquisition module is specifically configured to: obtain an image size corresponding to the first image and the second image, and perform channel splicing based on the first image and the second image to obtain the target image.

According to one or more embodiments of the present disclosure, the second determining module is specifically configured to: determine a cornea center based on the target position of the reflection light spot; detect a pupil position of the user, and determine a pupil center based on a preset refraction angle; and determine the gazing direction according to the cornea center and the pupil center.

According to one or more embodiments of the present disclosure, before obtaining the first image by acquiring the image of the cornea, the acquisition module is further configured to: perform image acquisition for an eye of the user to obtain a third image; determine, based on the third image, a first positional relationship between the cornea of the user and a camera unit for obtaining the first image; determine a target light source according to light source matrix information and the first positional relationship, where the light source matrix information is configured to characterize a second positional relationship between the camera unit and at least two alternative light sources for emitting detection light; and emit detection light to the cornea of the user based on the target light source.

In the third aspect, at least one embodiment of the present disclosure further provides an electronic device, and the electronic device includes a processor and a memory being in communication connection to the processor; and one or more computer-executable instructions are stored on the memory, and the processor is configured to execute the one or more computer-executable instructions stored on the memory to implement a method for detecting a direction of sight, which includes: after emitting detection light to a cornea of a user, obtaining a first image by acquiring an image of the cornea, where at least one reflection light spot is displayed in the first image, and the reflection light spot is formed by the cornea reflecting the detection light; generating a first prediction diagram by processing the first image based on a pre-trained image processing model, where the first prediction diagram characterizes a probability of a pixel on the first image being a target pixel, and the target pixel is a pixel constituting the reflection light spot; determining a target position of the reflection light spot according to the first prediction diagram; and determining a gazing direction of the user based on the target position of the reflection light spot.

In the fourth aspect, at least one embodiment of the present disclosure further provides a computer-readable storage medium, the computer-readable storage medium is configured to store computer-executable instructions, and the computer-executable instructions, when executed by a processor, cause the processor to implement the method for detecting the direction of sight according to any one of the embodiments of the present disclosure.

In the fifth aspect, at least one embodiment of the present disclosure further provides a computer program product, the computer program product includes a computer program, and the computer program, when executed by a processor, is configured to implement the method for detecting the direction of sight according to any one of the embodiments of the present disclosure.

The foregoing are merely descriptions of the preferred embodiments of the present disclosure and the explanations of the technical principles involved. It should be understood by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the scope of the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method actions, it should be understood that the subject matter defined in the appended claims is not necessarily limited to the particular features and actions described above. Rather, the particular features and actions described above are merely exemplary forms for implementing the claims.

1. A method for detecting a direction of sight, comprising:
after emitting detection light to a cornea of a user, obtaining a first image by acquiring an image of the cornea, wherein at least one reflection light spot is displayed in the first image, and the reflection light spot is formed by the cornea reflecting the detection light;
generating a first prediction diagram by processing the first image based on a pre-trained image processing model, wherein the first prediction diagram characterizes a probability of a pixel on the first image being a target pixel, and the target pixel is a pixel constituting the reflection light spot;
determining a target position of the reflection light spot according to the first prediction diagram; and
determining a gazing direction of the user based on the target position of the reflection light spot.

2. The method according to claim 1, wherein determining the target position of the reflection light spot according to the first prediction diagram comprises:
obtaining a preset first pixel threshold;
performing detection on the first prediction diagram according to the first pixel threshold to obtain a corresponding first binary diagram characterizing a position distribution of target pixels in the first image, wherein a pixel value of the target pixel is greater than the first pixel threshold;
performing, according to the first binary diagram, connected component merging on the target pixels to obtain a light spot region; and
determining the target position of the reflection light spot according to a center point of the light spot region.

3. The method according to claim 1, wherein determining the target position of the reflection light spot according to the first prediction diagram comprises:
performing a Gaussian fitting on the first prediction diagram to obtain at least one light spot region conforming to a Gaussian distribution; and
determining the target position of the reflection light spot according to a Gaussian expectation corresponding to the light spot region.

4. The method according to claim 1, further comprising:
obtaining a second image corresponding to the first image, wherein the second image is configured to characterize a contour range corresponding to the cornea in the first image; and
obtaining a target image according to the first image and the second image, wherein the target image is a collection of pixels in the contour range of the first image,
wherein generating the first prediction diagram by processing the first image based on the pre-trained image processing model, comprises:
generating the first prediction diagram by processing the target image according to the pre-trained image processing model.

5. The method according to claim 4, wherein the second image is a second binary diagram with an identical image size as the first image; and
obtaining the target image according to the first image and the second image comprises:
obtaining an image size corresponding to the first image and the second image, and
performing channel splicing based on the first image and the second image to obtain the target image.

6. The method according to claim 1, wherein determining the gazing direction of the user based on the target position of the reflection light spot comprises:
determining a cornea center based on the target position of the reflection light spot;
detecting a pupil position of the user, and determining a pupil center based on a preset refraction angle; and
determining the gazing direction according to the cornea center and the pupil center.

7. The method according to claim 1, wherein before obtaining the first image by acquiring the image of the cornea, the method further comprises:
performing image acquisition for an eye of the user to obtain a third image;
determining, based on the third image, a first positional relationship between the cornea of the user and a camera unit for obtaining the first image;
determining a target light source according to light source matrix information and the first positional relationship, wherein the light source matrix information is configured to characterize a second positional relationship between the camera unit and at least two alternative light sources for emitting detection light; and
emitting detection light to the cornea of the user based on the target light source.

8. An apparatus for detecting a direction of sight, comprising:
an acquisition module, configured to, after emitting detection light to a cornea of a user, obtain a first image by acquiring an image of the cornea, wherein at least one reflection light spot is displayed in the first image, and the reflection light spot is formed by the cornea reflecting the detection light;
a processing module, configured to generate a first prediction diagram by processing the first image based on a pre-trained image processing model, wherein the first prediction diagram characterizes a probability of a pixel on the first image being a target pixel, and the target pixel is a pixel constituting the reflection light spot;
a first determination module, configured to determine a target position of the reflection light spot according to the first prediction diagram; and
a second determination module, configured to determine a gazing direction of the user based on the target position of the reflection light spot.

9. The apparatus according to claim 8, wherein the first determination module is configured to:
obtain a preset first pixel threshold;
perform detection on the first prediction diagram according to the first pixel threshold to obtain a corresponding first binary diagram characterizing a position distribution of target pixels in the first image, wherein a pixel value of the target pixel is greater than the first pixel threshold;
perform, according to the first binary diagram, connected component merging on the target pixels to obtain a light spot region; and
determine the target position of the reflection light spot according to a center point of the light spot region.

10. The apparatus according to claim 8, wherein the first determination module is configured to:
perform a Gaussian fitting on the first prediction diagram to obtain at least one light spot region conforming to a Gaussian distribution; and
determine the target position of the reflection light spot according to a Gaussian expectation corresponding to the light spot region.

11. The apparatus according to claim 8, wherein the acquisition module is further configured to:
obtain a second image corresponding to the first image, wherein the second image is configured to characterize a contour range corresponding to the cornea in the first image, and
obtain a target image according to the first image and the second image, wherein the target image is a collection of pixels in the contour range of the first image; and
the processing module is configured to: generate the first prediction diagram by processing the target image according to the pre-trained image processing model.

12. The apparatus according to claim 11, wherein the second image is a second binary diagram with an identical image size as the first image; and
the acquisition module is configured to:
obtain an image size corresponding to the first image and the second image, and
perform channel splicing based on the first image and the second image to obtain the target image.

13. The apparatus according to claim 8, wherein the second determining module is configured to:
determine a cornea center based on the target position of the reflection light spot;
detect a pupil position of the user, and determining a pupil center based on a preset refraction angle; and
determine the gazing direction according to the cornea center and the pupil center.

14. The apparatus according to claim 8, wherein the acquisition module is further configured to:
perform image acquisition for an eye of the user to obtain a third image;
determine, based on the third image, a first positional relationship between the cornea of the user and a camera unit for obtaining the first image;
determine a target light source according to light source matrix information and the first positional relationship, wherein the light source matrix information is configured to characterize a second positional relationship between the camera unit and at least two alternative light sources for emitting detection light; and
emit detection light to the cornea of the user based on the target light source.

15. An electronic device, comprising:
a processor; and
a memory, being in communication connection to the processor,
wherein one or more computer-executable instructions are stored on the memory, and the processor is configured to execute the one or more computer-executable instructions stored on the memory to implement a method for detecting a direction of sight, which comprises:
after emitting detection light to a cornea of a user, obtaining a first image by acquiring an image of the cornea, wherein at least one reflection light spot is displayed in the first image, and the reflection light spot is formed by the cornea reflecting the detection light;
generating a first prediction diagram by processing the first image based on a pre-trained image processing model, wherein the first prediction diagram characterizes a probability of a pixel on the first image being a target pixel, and the target pixel is a pixel constituting the reflection light spot;
determining a target position of the reflection light spot according to the first prediction diagram; and
determining a gazing direction of the user based on the target position of the reflection light spot.

16. The electronic device according to claim 15, wherein determining the target position of the reflection light spot according to the first prediction diagram comprises:
obtaining a preset first pixel threshold;
performing detection on the first prediction diagram according to the first pixel threshold to obtain a corresponding first binary diagram characterizing a position distribution of target pixels in the first image, wherein a pixel value of the target pixel is greater than the first pixel threshold;
performing, according to the first binary diagram, connected component merging on the target pixels to obtain a light spot region; and
determining the target position of the reflection light spot according to a center point of the light spot region.

17. The electronic device according to claim 15, wherein determining the target position of the reflection light spot according to the first prediction diagram comprises:
performing a Gaussian fitting on the first prediction diagram to obtain at least one light spot region conforming to a Gaussian distribution; and
determining the target position of the reflection light spot according to a Gaussian expectation corresponding to the light spot region.

18. The electronic device according to claim 15, wherein determining the gazing direction of the user based on the target position of the reflection light spot comprises:
determining a cornea center based on the target position of the reflection light spot;
detecting a pupil position of the user, and determining a pupil center based on a preset refraction angle; and
determining the gazing direction according to the cornea center and the pupil center.

19. A computer-readable storage medium, wherein the computer-readable storage medium is configured to store computer-executable instructions, and the computer-executable instructions, when executed by a processor, cause the processor to implement the method for detecting the direction of sight according to claim 1.

20. A computer program product, comprising a computer program, wherein the computer program, when executed by a processor, is configured to implement the method for detecting the direction of sight according to claim 1.
